(19) United States
(12) Patent Application Publication
(10) Pub. No.: US 2008/0151978 A1
(43) Pub. Date: Jun. 26, 2008

(54) ANTENNA SHARING ARRANGEMENT FOR INFORMATION PROCESSING APPARATUS

(75) Inventor: Toshiyuki Hirota, Hino-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/961,919

(22) Filed: Dec. 20, 2007

(30) Foreign Application Priority Data
Dec. 22, 2006 (JP) 2006-346247

(51) Int. Cl. H04B 1/38

(52) U.S. Cl. 375/222

(57) ABSTRACT

According to one embodiment, an information processing apparatus includes a first transmission/reception antenna element, a second transmission/reception antenna element, a reception antenna element, a first wireless communication module which is connected to the first transmission/reception antenna element, a second wireless communication module which is connected to the second transmission/reception antenna element, and a distributor which is connected to the reception antenna element, the first wireless communication module and the second wireless communication module, and distributes a signal from the reception antenna element to the first wireless communication module and the second wireless communication module.

### CROSS-REFERENCE TO RELATED APPLICATIONS

This application is based upon and claims the benefit of priority from Japanese Patent Application No. 2006-346247, filed Dec. 22, 2006, the entire contents of which are incorporated herein by reference.

### BACKGROUND

1. Field

One embodiment of the invention relates to an information processing apparatus such as a personal computer, which has, for example, a wireless communication function.

2. Description of the Related Art

In recent years, various portable personal computers of a notebook type have been developed. The personal computer of this type includes a wireless communication function for executing wireless communication with an external device.

With recent wide use of various wireless communication schemes, there has begun to be a demand that a plurality of kinds of wireless communication modules, which correspond to a plurality of kinds of wireless communication schemes, be mounted in the portable personal computer.

However, if dedicated antennas corresponding to the plural kinds of wireless communication modules are provided, a large mounting space would be occupied by the antennas.

Jpn. Pat. Appln. KOKAI Publication No. 2001-285114 discloses two methods for sharing two antennas between two wireless modules.

In a first method, one antenna is shared between a transmission unit in a first wireless module and a transmission/reception unit in a second wireless module, and the other antenna is used by a reception unit in the first wireless module. In a second method, one antenna is shared between the transmission unit in the first wireless module and the transmission/reception unit in the second wireless module, and the other antenna is shared between the reception unit in the first wireless module and the transmission/reception unit in the second wireless module.

However, if the structure is adopted in which the transmission unit is connected to the antenna that is shared between the two wireless modules, as in the technique of Jpn. Pat. Appln. KOKAI Publication No. 2001-285114, the level of a signal, which comes from one of the wireless modules into the other wireless module via a diplexer, would increase.

In other words, since the power level of a transmission signal that is output from the transmission unit is relatively high, the transmission signal, though being attenuated by the diplexer, enters the other wireless module. Such a signal leakage may lead to a decrease in wireless communication speed.

It is thus necessary to realize a novel system configuration which can reduce the number of necessary antenna elements, without causing leakage of a signal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of an information processing apparatus according to an embodiment of the invention;

FIG. 2 is an exemplary block diagram showing a system configuration of the information processing apparatus according to the embodiment;

FIG. 3 is an exemplary block diagram for describing the structures of a first wireless communication module and a second wireless communication module, which are provided in the information processing apparatus according to the embodiment; and

FIG. 4 is an exemplary block diagram for describing the structure of a distributor which is provided in the information processing apparatus according to the embodiment.

### DETAILED DESCRIPTION

Various embodiments according to the invention will be described hereinafter with reference to the accompanying drawings. In general, according to one embodiment of the invention, there is provided an information processing apparatus comprising: a first transmission/reception antenna element; a second transmission/reception antenna element; a reception antenna element; a first wireless communication module which is connected to the first transmission/reception antenna element; a second wireless communication module which is connected to the second transmission/reception antenna element; and a distributor which is connected to the reception antenna element, the first wireless communication module and the second wireless communication module, and distributes a signal from the reception antenna element to the first wireless communication module and the second wireless communication module.

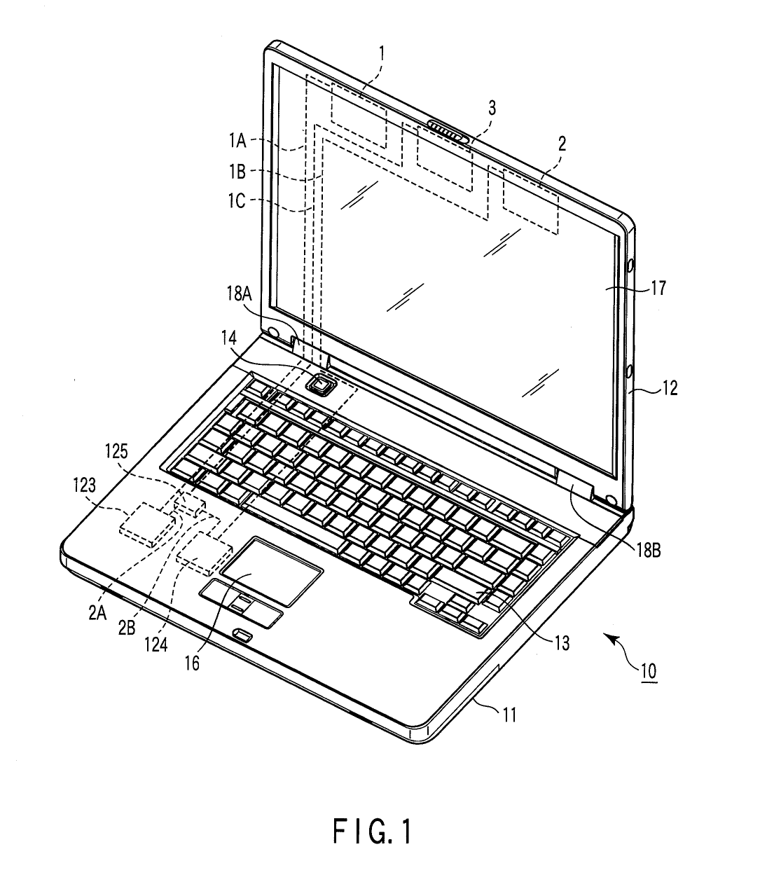

FIG. 1 shows an external appearance of an information processing apparatus according to the embodiment of the invention. The information processing apparatus is realized as a battery-powerable portable personal computer 10.

FIG. 1 is a perspective view of the computer 10 in the state in which a display unit of the computer 10 is opened. The computer 10 comprises a base unit 11 and a display unit 12. A display device, which is composed of an LCD (Liquid Crystal Display) 17, is built in the display unit 12. The display screen of the LCD 17 is disposed on an approximately central part of the display unit 12.

The display unit 12 is supported on a rear end portion of the base unit 11 via hinge portions 18A and 18B, and is attached so as to be rotatable between an open position where the upper surface of the base unit 11 is exposed and a closed position where the upper surface of the base unit 11 is covered with the display unit 12.

The base unit 11 is a main body of the computer 10 and has a thin box-shaped casing. A keyboard 13, a power button 14 for powering on/off the computer 10 and a touch pad 16 are disposed on the upper surface of the base unit 11. A first wireless communication module 123, a second wireless communication module 124 and a distributor 125, as well as electronic components such as a CPU, a memory and an I/O device, are provided within the base unit 11.

The first wireless communication module 123 is a wireless communication module which executes wireless communication with an external device according to a wireless communication scheme of, e.g., a third generation (3G) mobile phone. The first wireless communication module 123 is connected to a bus slot which is provided on a system board (also referred to as “printed circuit board”) on which various electronic components are mounted. In the 3G mobile phones, a frequency band of about 800 MHz to 2.2 GHz, for instance, is used.

Thus, in the case where the first wireless communication module 123 is realized as a wireless communication module (3G module) which executes wireless communication according to the 3G mobile phone, the first wireless communication module 123 executes wireless communication by using a wireless signal which belongs to a frequency band of, e.g., 800 MHz to 2.2 GHz.

The first wireless communication module 123 is configured to execute wireless communication with use of one transmission/reception antenna and one reception antenna. In this case, the transmission/reception of a wireless signal is executed by mainly using the transmission/reception antenna, and the reception antenna is used as an auxiliary one for the purpose of, for example, reception diversity. Even in the environment in which the transmission/reception antenna is positioned at a null point, the first wireless communication module 123 can receive a wireless signal by using the reception antenna.

The second wireless communication module 124 is a wireless communication module which executes wireless communication with an external device according to a wireless communication scheme such as the wireless LAN (WLAN). The second wireless communication module 124 is connected to a bus slot which is provided on the system board. In the wireless LAN, for example, a frequency band of 2.4 GHz to 2.5 GHz and a frequency band of 5.15 GHz to 5.74 GHz are used.

Thus, in the case where the second wireless communication module 124 is realized as a wireless communication module (WLAN module) which executes wireless communication according to the wireless LAN standard, the second wireless communication module 124 executes wireless communication by using a wireless signal which belongs to the frequency band of 2.4 GHz to 2.5 GHz or the frequency band of 5.15 GHz to 5.74 GHz.

The second wireless communication module 124 is configured to execute wireless communication with use of one transmission/reception antenna and one reception antenna. In this case, the transmission/reception of a wireless signal is executed by mainly using the transmission/reception antenna, and the reception antenna is used as an auxiliary one for the purpose of, for example, reception diversity. Even in the environment in which the transmission/reception antenna is positioned at a null point, the second wireless communication module 124 can receive a wireless signal by using the reception antenna.

In addition, if the second wireless communication module 124 is realized as a wireless communication module which executes wireless communication according to the IEEE 802.11n standard, the second wireless communication module 124 executes wireless communication by using a plurality of transmission/reception antennas, for instance, two transmission/reception antennas, and a single reception antenna.

In the present embodiment, in order to reduce the number of necessary antennas and to prevent coming-in of a transmission signal from one of the wireless communication modules to the other wireless communication module, such an antenna connection mode is adopted that only a reception antenna element is shared between the first wireless communication module 123 and the second wireless communication module 124 and transmission/reception antennas are individually connected to the first wireless communication module 123 and the second wireless communication module 124. The reception antenna element is connected only to a reception unit of the first wireless communication module 123 and to a reception unit of the second wireless communication module 124. A transmission/reception unit of the first wireless communication module 123 and a transmission/reception unit of the second wireless communication module 124 are connected to the dedicated transmission/reception antennas, and are not connected to the reception antenna element. Therefore, while the coming-in of the transmission signal from one wireless communication module to the other wireless communication module is prevented, the number of necessary antennas can be reduced by one. A concrete structure for this is described below.

Specifically, a first transmission/reception antenna element 1, a second transmission/reception antenna element 2 and a reception antenna element 3 are disposed within the display unit 12.

The first transmission/reception antenna element 1 is a transmission/reception antenna which is used by the first wireless communication module 123. The first transmission/reception antenna element 1 is configured such that a resonance frequency band of the first transmission/reception antenna element 1 includes a frequency band (e.g., 800 MHz to 2.2 GHz) for the first wireless communication module 123. The first wireless communication module 123 is connected to the first transmission/reception antenna element 1 via a cable (antenna cable) 1A. The cable 1A is led from the base unit 11 into the display unit 12 through an opening which is provided in the hinge portion 18A.

The second transmission/reception antenna element 2 is a transmission/reception antenna which is used by the second wireless communication module 124. The second transmission/reception antenna element 2 is configured such that a resonance frequency band of the second transmission/reception antenna element 2 includes a frequency band (e.g., 2.4 GHz to 2.5 GHz, 5.15 GHz to 5.74 GHz) for the second wireless communication module 124. The second wireless communication module 124 is connected to the second transmission/reception antenna element 2 via a cable (antenna cable) 1B. The cable 1B is led from the base unit 11 into the display unit 12 through the opening which is provided in the hinge portion 18A.

The reception antenna element 3 is a shared antenna for reception, which is shared between the first wireless communication module 123 and second wireless communication module 124. The reception antenna element 3 is, for example, a wide band antenna, and the reception antenna element 3 is configured such that a resonance frequency band of the reception antenna element 3 includes both the frequency band (e.g., 800 MHz to 2.2 GHz) for the first wireless communication module 123 and the frequency band (e.g., 2.4 GHz to 2.5 GHz, 5.15 GHz to 5.74 GHz) for the second wireless communication module 124.

The first wireless communication module 123 and the second wireless communication module 124 are connected to the reception antenna element 3 via the distributor 125 (also referred to as “divider” or “separator”).

Specifically, the distributor 125 is connected to the reception antenna element 3 via a cable (antenna cable) 1C. The cable (antenna cable) 1C is led from the base unit 11 into the display unit 12 through the opening which is provided in the hinge portion 18A. The distributor 125 is also connected to the first wireless communication module 123 via a cable (antenna cable) 2A and to the second wireless communication module 124 via a cable (antenna cable) 2B. The distributor 125 receives a signal from the reception antenna 3 via the cable 1C and distributes the received signal to the first wireless communication module 123 and second wireless communication module 124 via the cables 2A and 2B, respectively.

As described above, only the reception antenna element 3 is shared between the wireless communication module 123 and second wireless communication module 124 via the distributor 125. The first wireless communication module 123 and the first transmission/reception antenna 1 are directly connected via the cable 1A, and the second wireless communication module 124 and the second transmission/reception antenna 2 are directly connected via the cable 1B. Thereby, a transmission signal from one of the wireless communication modules is prevented from entering the other wireless communication module. It is thus possible to reduce the number of antenna elements, without causing a problem due to signal leakage.

Since the distributor 125 is provided within the base unit 11, the total length of antenna cables can be made smaller than in the structure in which the distributor 125 is disposed within the display unit 12.

In general, there is a tendency that the gain of an antenna decreases as the band of the antenna becomes wider. In addition, if the distributor 125 is interposed between an antenna and wireless communication modules, there occurs loss of a reception signal due to the distributor 125. However, the first wireless communication module 123 and second wireless communication module 124 are connected not only to the reception antenna element 3, but also to the dedicated transmission/reception antenna elements (first transmission/reception antenna element 1 and second transmission/reception antenna element 2). Therefore, even if the first wireless communication module 123 and second wireless communication module 124 are connected to the wide-band reception antenna element 3 via the distributor 125, there is little influence due to a decrease in level of a reception signal.

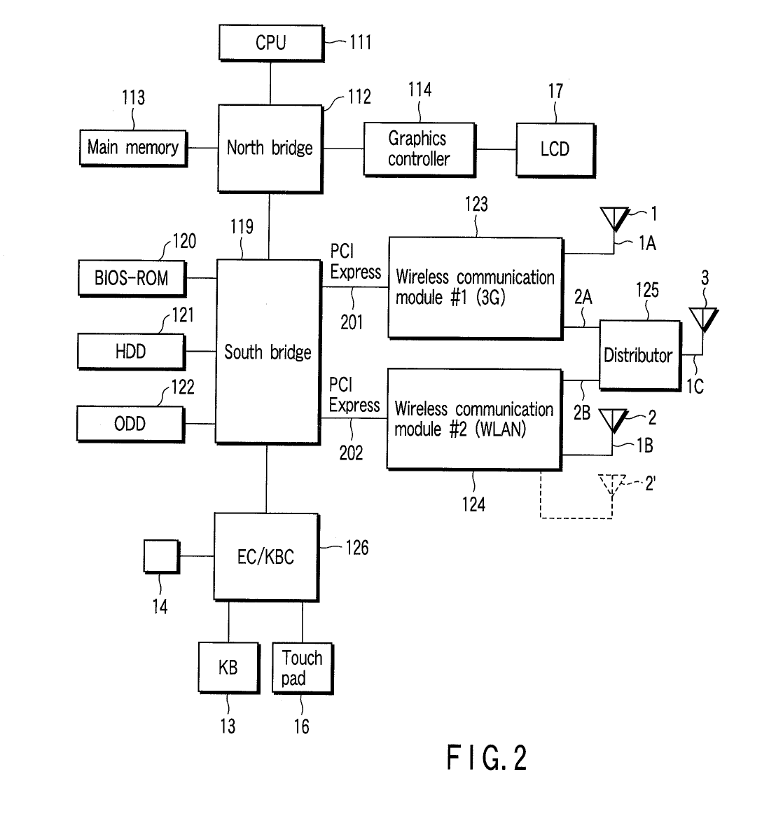

Next, referring to FIG. 2, the system configuration of the computer 10 is described.

The computer 10 comprises a CPU 111, a north bridge 112, a main memory 113, a graphics controller 114, a south bridge 119, a BIOS-ROM 120, a hard disk drive (HDD) 121, an optical disc drive (ODD) 122, first wireless communication module 123, second wireless communication module 124, distributor 125 and an embedded controller/keyboard controller IC (EC/KBC) 126.

The CPU 111 is a processor that controls the operation of the computer 10. The CPU 111 executes an operating system (OS) and various application programs, which are loaded from the HDD 121 into the main memory 113. The CPU 111 also executes a system BIOS (Basic Input/Output System) that is stored in the BIOS-ROM 120. The system BIOS is a program for hardware control.

The north bridge 112 is a bridge device that connects a local bus of the CPU 111 and the south bridge 119. In addition, the north bridge 112 has a function of executing communication with the graphics controller 114 via, e.g., an AGP (Accelerated Graphics Port) bus.

The graphics controller 114 is a display controller which controls the LCD 17 that is used as a display monitor of the computer 10.

The south bridge 119 is a bridge device which controls various I/O devices. The first wireless communication module 123 is connected to the south bridge 119 via a bus 201 such as a PCI Express bus. The first wireless communication module 123 is connected to the first transmission/reception antenna element 1 and is also connected via the distributor 125 to the reception antenna 3. In addition, the second wireless communication module 124 is connected to the south bridge 119 via a bus 202 such as a PCI Express bus. The second wireless communication module 124 is connected to the second transmission/reception antenna element 2 and is also connected via the distributor 125 to the reception antenna 3. If the second wireless communication module 124 is a wireless communication module which executes wireless communication according to the IEEE 802.11n standard, a second transmission/reception antenna element 2′ is further disposed in the display unit 12, and the second wireless communication module 124 is connected to the two second transmission/reception antenna elements 2 and 2′ and is connected via the distributor 125 to the reception antenna element 3.

The embedded controller/keyboard controller IC (EC/KBC) 125 is a 1-chip microcomputer in which an embedded controller for power management and a keyboard controller for controlling the keyboard (KB) 13 and touch pad 16 are integrated.

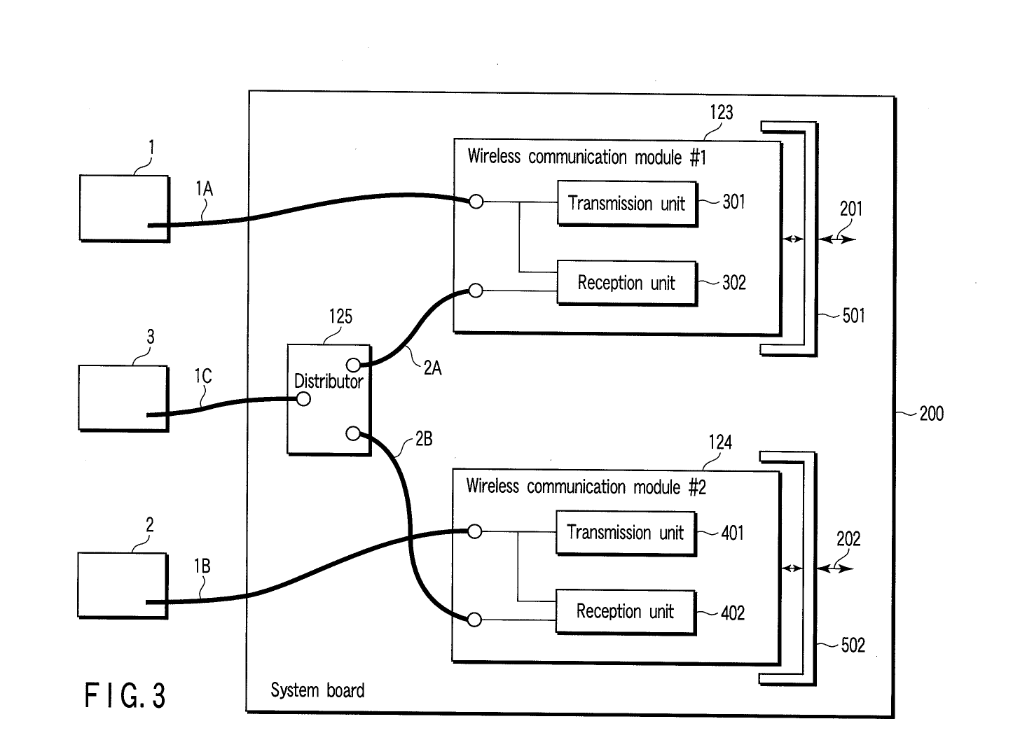

Next, referring to FIG. 3, the structures of the first wireless communication module 123 and second wireless communication module 124 are described.

The first wireless communication module 123 is composed of an expansion card such as a mini PCI Express card, and is connected to a bus slot 501 which is provided on the system board 200. The bus slot 501 is connected to the above-described bus 201 that is provided on the system board 200. Various electronic components, such as the above-described CPU 111, north bridge 112, main memory 113, graphics controller 114, south bridge 119, BIOS-ROM 120 and embedded controller/keyboard controller IC (EC/KBC) 126, are mounted on the system board 200.

The first wireless communication module 123 includes a transmission unit 301 and a reception unit 302. The transmission unit 301 and reception unit 302 are connected to the first transmission/reception antenna element 1 via the cable 1A that connects the first wireless communication module 123 and the first transmission/reception antenna element 1. In addition, the reception unit 302 is connected to the distributor 125 via the cable 2A that connects the first wireless communication module 123 and the distributor 125.

The second wireless communication module 124 is also composed of an expansion card such as a mini PCI Express card, and is connected to a bus slot 502 which is provided on the system board 200. The bus slot 502 is connected to the above-described bus 202 that is provided on the system board 200.

The second wireless communication module 124 includes a transmission unit 401 and a reception unit 402. The transmission unit 401 and reception unit 402 are connected to the second transmission/reception antenna element 2 via the cable 1B that connects the second wireless communication module 124 and the second transmission/reception antenna element 2. In addition, the reception unit 402 is connected to the distributor 125 via the cable 2B that connects the second wireless communication module 124 and the distributor 125.

In the case where the second wireless communication module 124 is realized as a wireless communication module which executes wireless communication according to the IEEE 802.11n standard, a third transmission/reception antenna is disposed within the display unit 12, and each of the transmission unit 401 and reception unit 402 is also connected to the third transmission/reception antenna via a cable which connects the third transmission/reception antenna and the second wireless communication module 124.

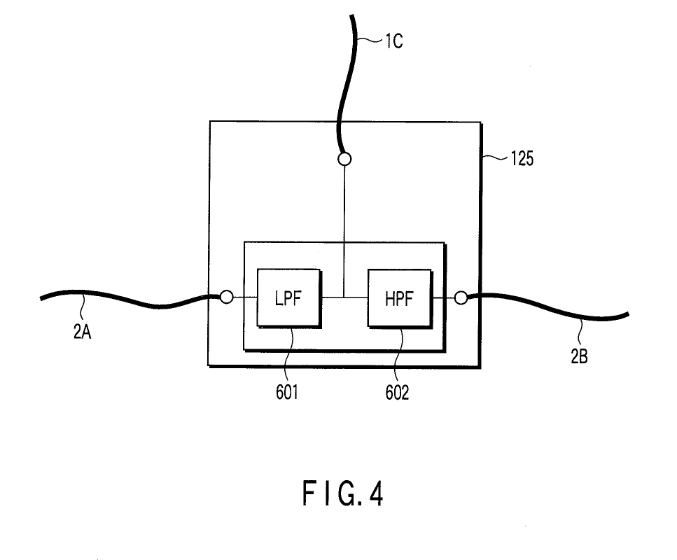

FIG. 4 shows an example of the structure of the distributor 125.

The distributor 125 includes two filter circuits 601 and 602. The filter circuit 601 is a low-pass filter (LPF). The filter circuit 601 is connected to the reception antenna element 3. The filter circuit 601 filters signals from the reception antenna element 3 (i.e. RF signals received by the reception antenna element 3) to pass a signal having a frequency component of not higher than an upper limit (e.g., 2.2 GHz) of the frequency band corresponding to the first wireless communication module 123, and outputs the signal having this frequency component to the first wireless communication module 123.

The filter circuit 602 is a high-pass filter (HPF). The filter circuit 602 is connected to the reception antenna element 3. The second circuit 602 filters signals from the reception antenna element 3 (i.e. RF signals received by the reception antenna element 3) to pass a signal having a frequency component of not lower than a lower limit (e.g., 2.2 GHz) of the frequency band corresponding to the second wireless communication module 124, and outputs the signal having this frequency component to the second wireless communication module 124.

As has been described above, in the computer 10, since the reception antenna element 3 is shared between the first wireless communication module 123 and the second wireless communication module 124, the number of components can be reduced. Specifically, one component, that is, one antenna, can be dispensed with, and the space for disposing one antenna can be saved. Therefore, all necessary antenna elements can be disposed, for example, in an upper end portion of the display unit 12.

Besides, the number of cables, which are passed through the hinge portion, can be reduced. Since only the reception antenna element 3 is shared and the transmission/reception antennas are individually connected to the first wireless communication module 123 and the second wireless communication module 124, it is possible to prevent a transmission signal from one of the wireless communication modules from directly entering the other wireless communication module.

The present embodiment shows, by way of example, the structure in which the display unit 12 is supported on the base unit 11 via two hinge portions. Alternatively, the display unit 12 may be supported on the base unit 11 via only one hinge portion.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
first and second transceiver antenna elements;
transceivers reception antenna element;
a first wireless communication module connected to the first transceiver antenna element;
a second wireless communication module connected to the second transceiver antenna element; and
a distributor connected to the reception antenna element, the first wireless communication module, and the second wireless communication module, the distributor being configured to distribute a signal from the reception antenna element to the first and second wireless communication modules.

2. The information processing apparatus of claim 1, wherein the first wireless communication module comprises a first transmission unit and a first reception unit that are connected to the first transceiver antenna element, the first reception unit being also connected to the reception antenna element via the distributor, and
wherein the second wireless communication module comprises a second transmission unit and a second reception unit that are connected to the second transceiver antenna element, the second reception unit being also connected to the reception antenna element via the distributor.

3. The information processing apparatus of claim 1, wherein the first wireless communication module is configured to transmit and to receive a wireless signal of a first frequency band, and the second wireless communication module is configured transmit and to receive a wireless signal of a second frequency band which is higher than the first frequency band, and
wherein the distributor comprises a low-pass filter configured to filter signals from the reception antenna element to pass a first signal having a frequency component not higher than an upper limit of the first frequency band, and to output the first signal to the first wireless communication module, and wherein the distributor additionally comprises a high-pass filter configured to filter signals from the reception antenna element to pass a second signal having a frequency component not lower than a lower limit of the second frequency band, and to output the second signal to the second wireless communication module.

4. The information processing apparatus of claim 1, further comprising a third transceiver antenna element, wherein the second transmission unit and the second reception unit of the second wireless communication module are connected to the second transceiver antenna element and the third transceiver antenna element.

5. An information processing apparatus comprising;
a base unit;
a display unit supported on the base unit via a hinge portion, the display unit being rotatable between an open position where an upper surface of the base unit is exposed and a closed position where the upper surface of the bas unit is covered;
first and transceiver antenna elements disposed within the display unit;
a reception antenna element disposed within the display unit;
a first wireless communication module provided within the base unit and comprising a first transmission unit and a first reception unit, the first transmission unit and the first reception unit being connected to the first transceiver antenna element via a first cable;
a second wireless communication module which is provided within the base unit and comprising a second transmission unit and a second reception unit, the second transmission unit and the second reception unit being connected to the second transceiver antenna element via a second cable; and
a distributor provided within the base unit and configured to connect to: (i) the reception antenna element via a third cable, (ii) the first reception unit of the first wireless communication module via a fourth cable, (iii) the second reception unit of the second wireless communication module via a fifth cable, the distributor further configured to receive a signal from the reception antenna element via the third cable, and to distribute the received signal to the first reception unit of the first wireless communication module and to the second reception unit of the second wireless communication module via the fourth cable and the fifth cable, respectively.

6. The information processing apparatus according to claim 5, wherein the first cable, the second cable, and the third cable are led from the base unit into the display unit through an opening in the hinge portion.

7. The information processing apparatus according to claim 5, wherein the first wireless communication module is configured to transmit and receive a wireless signal of a first frequency band, and the second wireless communication module is configured to transmit and receive a wireless signal of a second frequency band which is higher than the first frequency band,
wherein the distributor comprises a low-pass filter configured to filter signals from the reception antenna element to pass a first signal having a frequency component not higher than an upper limit of the first frequency band, and to output the first signal to the first reception unit, and
wherein the distributor additionally comprises a high-pass filter configured to filter signals from the reception antenna element to pass a second signal having a frequency band, and to output the second signal to the second reception unit.
